(19) United States
(12) Patent Application Publication
(10) Pub. No.: US 2006/0198423 A1
(43) Pub. Date: Sep. 7, 2006

(54) Thermochromic body cavity device

(76) Inventor: Joel Lawrence Clupper, Woodland Hills, CA (US)

Correspondence Address: BERT P. KRAGES II;ATTORNEY AT LAW, 6665 SW HAMPTON ST, PORTLAND, OR, 97223, US

(21) Appl. No.: 11/072,100

(22) Filed: Mar. 4, 2005

(51) Int. Cl. G01K 11/00

(52) U.S. Cl. 374/162

(57) ABSTRACT

A body cavity device of cylindrical, spherical, annular, or tubular form with thermochromic pigments that change color in response to temperature changes. The device can be used to induce stimulation within a body cavity such as a vagina, discern the temperature within, and assess the state of vasocongestion based on correlation to temperature. The device can also be used in other applications where taking temperature measurements within the confines of an externally accessible body cavity is desired.

### CROSS-REFERENCED TO RELATED APPLICATIONS:

None

### FEDERALLY SPONSORED RESEARCH:

No

### SEQUENCE LISTING OR PROGRAM:

Not Applicable

### FIELD OF THE INVENTION

This invention relates to body cavity devices, especially those used to induce stimulation within cavities such as the vagina or anus. The devices can also be used in applications where assessing the temperature within the confines of an externally accessible body cavity is desired. The invention makes use of the temperature-indicating properties of thermochromic pigments.

### BACKGROUND OF THE INVENTION

The use of body cavity devices is well known in the prior art. A traditional application of such devices has been as sex aids used for the purpose of inducing sexual stimulation and as prophylactics against pregnancy or disease transmission. However, they have also been adapted to measure blood flow and temperature in the tissues surrounding body cavities by the inclusion of sensing instruments within the confines of the device. When used as sexual aids or prophylactics, such devices are most commonly embodied in either: (1) a cylindrical form which is inserted into a cavity such as a vagina or anus and externally manipulated to induce stimulation, (2) in the form of one or more spherical or ovoid beads which are inserted into a cavity and from which stimulation is induced by rocking or otherwise moving the pelvic muscles, or (3) in the form of a sheath that covers the object to be inserted into the body cavity. When used as instruments to measure physiological parameters, such devices are designed so as to place a sensing device in an appropriate location. A well known application in this context is the vaginal photoplethysmograph which is a cylindrical instrument that uses reflected light to sense blood flow changes in the vagina.

The use of thermochromic pigments in various applications is also well known. Such pigments typically comprise an electron-donating chromogenic substance, an electron-accepting substance, and a solvent which undergo a reversible color change in response to a change in the ambient temperature. The color change which takes place may be from one color to another, from colored to colorless, or from colorless to colored. Pigments may be combined so that several temperatures in a predetermined range can be indicated by different colors. Common commercial applications include the use in novelty jewelry, coffee mugs, fabrics, bank checks, and aquarium thermometers.

The temperature within the body cavities of humans, as well as other warm-blooded species, depends on factors such as activity level, ovulation, and sexual arousal. For example, the temperature of the vagina fluctuates during the day depending on the level of physical activity and food intake. It is generally accepted that the basal body temperature, i.e., the temperature upon awakening in the morning, can be used to indicate whether a female is ovulating. Before ovulation the temperature may vary from day to day by about 0.1 degree Celsius but just after ovulation the temperature rises by 0.2-0.6 degrees Celsius. The temperature changes experienced during sexual arousal vary among individual depending on factors such as the level of vasocongestion in the tissues surrounding the genital region, the rate of metabolic energy expenditure, and movement of organs such changes in the walls of the vagina and the placement of the uterus relative to the cervix. E.g., Giulano, F., et. al., “Vaginal physiological changes in a model of sexual arousal in anesthetized rats,” Am J Physiol Regulatory Integrative Comp Physiol 2001, R140-R149; Henson, D. E., et. al., “Labial and Vaginal Blood Volume Responses to Visual and Tactile Stimuli,” Archives of Sexual Behavior, 1982, 11: 23-31; Abramson P. R., et. al., “Thermographic Measurement of Sexual Arousal: A Discriminant Validity Analysis,” 1981, Archives of Sexual Behavior, 10: 171-176.

### SUMMARY OF THE INVENTION

The invention consists of a body cavity device which has thermochromic pigments either embedded into or affixed onto so that they are visible when either a exterior or interior surface is viewed. The thermochromic pigments provide a means of indicating the temperature within a body cavity once the device is inserted and equilibrates in temperature with the cavity. The form of the invention can be generally cylindrical, generally spherical, or a sheath depending on the configuration that is most suitable for the desired application.

The generally cylindrical embodiment consists of a shaft of a diameter suitable for inserting into a body cavity with a first end and a second end. A conical head may be provided on the second end of the shaft to facilitate insertion and subsequent movement within the cavity. The shaft an head portions could feature ridges, differential diameters, and like protrusions as are well know in the prior art. The shaft and conical head can be fabricated of diverse materials with either a rigid or semi-rigid properties. For example, rigid materials such as plastic or glass could have one or more thermochromic pigments are bound within or applied in the form of a single or multi-layer coating system. Alternatively, the embodiment could be constructed of a clear or translucent semi-rigid materials such as a silicone rubber in which the thermochromic pigment is incorporated. Alternatively, the embodiment in either a rigid or semi-rigid form could be constructed such that thermochromic pigment in a liquid or gel form is confined within a hollow space within the device.

The generally spherical embodiment consists of one or more spherical or ovoid beads ranging about 10 to 40 millimeters in diameter. When this embodiment encompasses a plurality of beads, they can be connected by a cord or tube made of a suitable material such as nylon. The materials used to construct the beads and methods for incorporating or affixing the thermochromic pigment are the same as for the cylindrical embodiment.

The sheath embodiment consists of a flexible ring or tubular body that can be slipped over an object intended to be inserted into a body cavity and thereby facilitate the taking of thermochromic measurements within such cavity. One such application is a thermochromic condom which would consist of a flexible tubular body having an open and a closed end formed of thin elastomeric material. Thermochromic pigments are bound within the material used to form the condom. However, the sheath embodiment could also be used to provide a cylindrical devices with a thermochromic measurement capability. For instance, It could also be fabricated as a ring or tube with two open ends and placed over a suitable object.

The thermochromic pigment can be incorporated into the invention in a number of ways depending on the design and materials used to construct the invention. Thermochromic pigments are readily mixed with plastic or rubber formulations which are then forced into a mold to manufacture the invention. Other nonexclusive methods include: (1) incorporating the thermochromic pigment into a gel or liquid that fills a confined hollow space within the device and (2) coating the surface of the device with thermochromic coating that is further sealed with a top glaze of coating.

When the device is inserted into a body cavity, it is warmed by the heat within. The temperature within the cavity can be assessed visually by noting the color of the thermochromic pigment shortly after withdrawing the device. Alternatively, the device could feature a viewing window at the proximal end which allows a viewer to see into the device without the need for withdrawal from the cavity. A means for illuminating the internal portion of the device, such as a light emitting diode (LED), could be incorporated into the device to facilitate such viewing. In addition to direct visual assessment, the temperature indicated by the device can be ascertained by using optical sensors that detect the color indicated by a specific temperature. For example, a semiconductor light source such as laser diode or LED can be used in conjunction with fiber optic cables to enable to temperatures to be read at some distance from the sensing portion contained within the device.

One application would be to use the temperature readings as a means of visual assessment of the degree of readiness for coitus. It is well established in the medical literature that sexually arousal in a woman correlates to the degree of blood engorgement and the production of transudate fluid in the vagina which are necessary precursors for comfortable coitus. Absent sufficient stimulation, the arousal process may not produce sufficient changes in the shape and lubricating abilities of the vagina to ensure a pleasant sexual experience. The cylindrical and spherical embodiments of the invention provides the partner of the person undergoing foreplay stimulation with a means of providing stimulation while simultaneously monitoring temperature changes in the vagina that correlate to the level of vasocongestion present in the surrounding tissues. The temperature that best correlates to the preferred state of readiness can be determined through empirical experimentation and used a guideline to ascertain when to commence coitus. Similarly, the invention could be used by a person engaged in autoerotic activity to provide feedback on changes within the measured cavity during various stages of perceived arousal.

When the invention is embodied in the form of a condom, it is first warmed by the person wearing the device and is secondarily affected by the heat contributed by the other person upon penetration into the body cavity. The device used in this embodiment thus could provide a means of assessing body cavity temperature during coitus and similar activities, overcomes a shortcoming in the prior art in which temperature measurements have been limited to unpartnered sexual stimulation. As discussed previously, the embodiments based a sheath do not necessarily have to be condoms but could also take the form of a ring or sleeve with two open ends that slips over an object to be inserted into a body cavity. Such devices would allow users to modify existing objects to provide them with the capability of taking thermochromic measurements.

As noted above, the cylindrical and spherical embodiments of the invention could also incorporate a detection means which enables the taking of temperature measurements without the need to remove the device from the body cavity. Such devices could be useful to medical researchers in evaluating spatial and temporal changes in body cavity temperature. For example, fiber optic cables could be arrayed in a cylindrical embodiment such that they attach to detectors at intervals along the longitudinal orientation of the shaft and thus facilitate the measurement of the temperature profile throughout the length of a body cavity. The cables could likewise be arranged in the spherical embodiment so that a detector is located in a plurality of spheres. In either embodiment, the fiber optic cable would transmit information from the detector to a device that would process the information and reveal the measurement in a discernable form to a viewer. In addition to medical research applications, the fiber optic cable could transmit information to a device that would provide feedback to persons performing pelvic floor muscle exercises such as the kegel exercises that are well known to persons who are experienced in the prior art.

### BRIEF DESCRIPTION OF THE SEVERAL VIEWS OF THE DRAWINGS

A detailed description of the invention is hereafter described with specific reference being made to the drawings in which:

FIG. 1 is a perspective view of an cylindrical embodiment of the invention;

FIG. 2 is a perspective view of an embodiment of the invention showing the incorporation of fiber optic cables and detectors;

FIG. 3 is a perspective view of an embodiment of the invention showing a viewing port in the first end;

FIG. 4 is a side view of a spherical embodiment of the invention showing two beads connected by a cord;

FIG. 5 is a side view of a spherical embodiment showing a plurality of beads connected by tubing and incorporating fiber optic cables and detectors; and

FIG. 6 is a side view showing an embodiment as a condom.

### DETAILED DESCRIPTION OF THE INVENTION

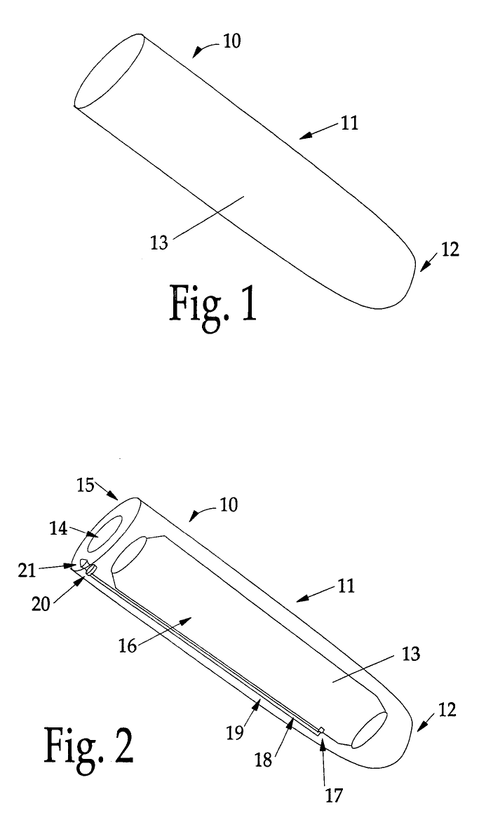

In the embodiment of the invention shown in FIG. 1, the invention is indicated generally by reference numeral 10. This embodiment consists of a generally cylindrical shaft 11 with a conical second end 12. The shaft and conical end may be made of any desired material but in the preferred embodiment would be a rigid material such as borosilicate glass, metal, or acrylic plastic. The shaft 11 and conical end 12 are covered with a thermochromic coating 13 which is affixed to the shaft in the form of a polymeric coating such as a polyacrylate that incorporates a thermochromic pigment. The thermochromic coating 13 changes color when a predetermined temperature is reached and may be provided with the ability to change to additional colors as the temperature further increases. Alternatively the shaft 11 and conical end 13 could be constructed of materials such as silicone, rubber, or semi-rigid thermoplastic in which the thermochromic pigment could be incorporated into the plastic resin or uncured rubber prior to injection molding or extrusion.

The embodiment shown in FIG. 2. has a transparent port 14 in the base end 15 which enables viewing into a chamber 16 inside the shaft 11. The chamber is illuminated by a light emitting diode (LED) 17 which is connected by wires 18 and 19 to a battery 20 and switch 21 affixed to the base end 15. Pressing switch 21 activates the LED 17 which enables a viewer to look through the transparent port 15 and see the thermochromic pigment 13 lining the wall of the chamber 16. This allows a viewer to ascertain the body cavity temperature without having to remove the body cavity device 10 from the body cavity. Alternatively, the chamber 16 could be filled with a transparent or translucent liquid or semisolid gel which contains thermochromic pigment in which case the LED 17 would enable the viewer to ascertain the color of the thermochromic pigment by backlighting it.

The embodiment shown in FIG. 3 uses a fiber optic line 22 to transmit light to a chamber 16 inside the device for the purpose of illuminating the thermochromic material 13 lining the chamber. The fiber optic line 22 may be provided with multiple fibers to transmit light into chamber 16 and in return transmit a light signal from chamber 16. One or more of the fibers may be used to provide a direct optical link between the inside of the chamber 16 thereby providing the ability to directly observe the thermochromic material 13 and its color. In the embodiment shown in FIG. 3., the fibers may be connected to one or more detectors 23 which provides the ability to detect the color of the light reflected from the thermochromic material 13 and input a signal into the fiber optic line 22 for transmission outside the device.

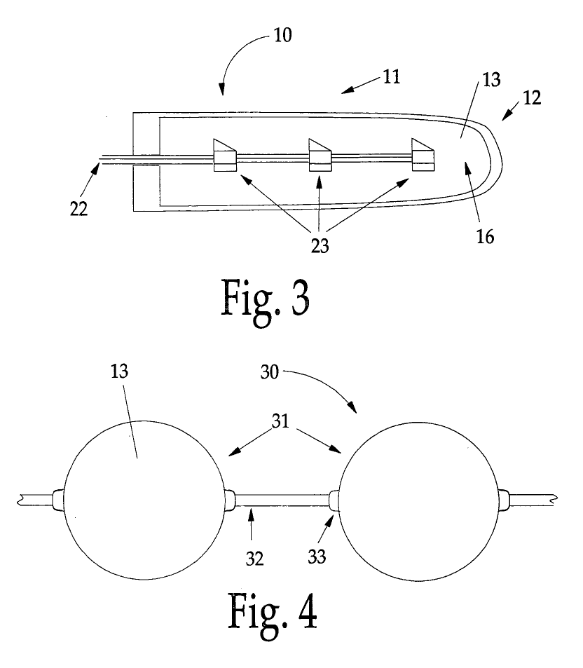

In the embodiment of the invention shown in FIG. 4, the invention is indicated generally by reference numeral 30. This embodiment consists of one or more spherical beads 31 that are may be affixed to a cord 32 running through the interior of the beads. The beads may be made of any desired material but in the preferred embodiment would be a hard material such as borosilicate glass, metal, or acrylic plastic. As is known in the art, the beads are connected to the cord 32 by passing the string through an opening formed through the interior thereof. A knot 33, or other form of clasp, is secured to the cord 32 at each end of a bead 31 to prevent it from sliding along the length of the cord 32. The free end of the cord could have a handle portion in the form of a loop, ring, or the like. The beads 31 are covered with a thermochromic coating 13 which is affixed to the bead in the form of a polymeric coating such as a polyacrylate that incorporates a thermochromic pigment. The thermochromic coating 13 changes color when a predetermined temperature is reached and may be provided with the ability to change to additional colors as the temperature further increases. Alternatively the beads 31 could be constructed of materials such as silicone, rubber, or thermoplastics in which the thermochromic pigment is incorporated into the plastic resin or uncured rubber prior to injection molding or extrusion.

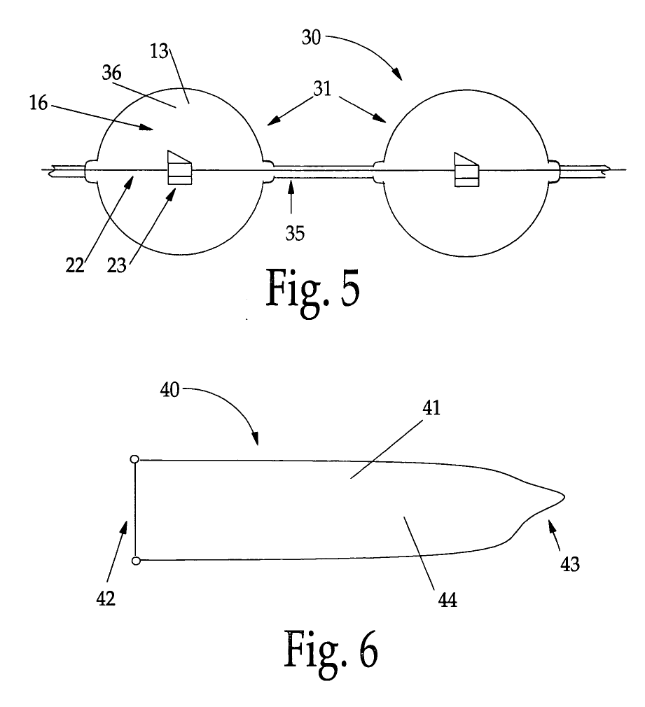

In the embodiment of the invention shown in FIG. 5, the invention is indicated generally by reference numeral 30. This embodiment consists of one or more hollow spherical beads 31 of which the interior walls 36 are covered with or expose a thermochromic coating 13 which can be either affixed on or incorporated into the wall of the bead as described in the previous embodiment. The beads 31 are affixed to tubing 35 that is rigidly joined to the exterior surface of the beads and permits a fiber optic line 22 to run into the interior of the beads, The fiber optic line 22 may be provided with multiple fibers to transmit light into one or more beads for the purpose of illuminating the interior walls 36 thereof and also to transmit light reflected from the interior walls via the fiber optic line 22 to a location outside the device. One or more of the fibers may be used to provide a direct optical link to the inside of the chamber 16 thereby providing the ability to directly observe the thermochromic material 13 and it color. In the embodiment shown in FIG. 5, the fibers may be connected to one or more detectors 23 which provide the ability to detect the color of the light reflected from the thermochromic material 13 and input a signal into the fiber optic line 22 for transmission outside the device.

In the embodiment of the invention shown in FIG. 6, the invention is indicated generally by reference numeral 40. This embodiment consists or a thin elastic sheath 41 of a generally cylindrical or tubular configuration and having a and open end 42 and a rounded closed end 43. The sheath 41 consists of a conventional material such as latex, urethane, rubber or the like, that has thermochromic pigments 44 embedded therein. An alternative embodiment, not shown, would have two open ends and be suitable for using as a thermochromic sleeve for covering a non-thermochromic body cavity device or a similarly shaped object to give them the ability to take thermochromic measurements when inserted into a body cavity.

The above examples and disclosures are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein, which equivalents are also intended to be encompassed by the claims attached hereto. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device for inserting into an externally accessible body cavity comprising an elongated, generally cylindrical shaft having first and second ends, being constructed of sufficiently rigid material so as to minimize bending when said shaft is inserted; said shaft being at least partially constructed from at least one thermochromic material which exhibits a predetermined detectable change in color when the material is in contact with an object having a predetermined temperature.

2. The device of claim 1 in which the thermochromic material is affixed to the outer surface of the shaft.

3. The device of claim 1 in which the thermochromic material is embodied into the material comprising the shaft.

4. The device of claim 1 in which the thermochromic material is visible within a hollow space within the shaft and viewable through a transparent portion of the shaft or ends.

5. The device of claim 1 in which the thermochromic material is visible within a hollow space within the shaft and viewable through a transparent portion of the shaft or ends, and which can be illuminated by a light source within the shaft that is selectively operated by a switch.

6. The device of claim 1 in which the thermochromic material is present on the interior wall of a hollow shaft; which can be illuminated by a light source constructed and arranged to F transmit light to the inside of the shaft; and a detector that is constructed and arranged to detect reflected light and produce a signal.

7. The device of claim 1 in which the thermochromic material is present on the surface of the interior wall of a hollow shaft; which can be illuminated by a light source positioned inside the shaft and a detector that is constructed; and arranged to detect reflected light and produce a signal.

8. A device for inserting into an externally accessible body cavity comprising one or more generally spherical elements being constructed of sufficiently rigid material so as to minimize collapse when inserted; said elements being at least partially constructed from at least one thermochromic material which exhibits a predetermined detectable change in color when the material is in contact with an object having a predetermined temperature.

9. The device of claim 8 in which the elements are joined by a flexible cord.

10. The device of claim 8 in which the thermochromic material is affixed to the outer surface of an element.

11. The device of claim 8 in which the thermochromic material is embodied into the material comprising an element.

12. The device of claim 8 in which the thermochromic material is confined within a hollow space within an element and is viewable through a transparent portion of the wall of the element.

13. The device of claim 8 in which the thermochromic material is confined within a hollow space within an element and viewable through a transparent portion of the wall of the element, and which can be illuminated by a light source within the element that is selectively operated by a switch.

14. The device of claim 8 in which the thermochromic material is present on the interior wall of a hollow element; which can be illuminated by a light source constructed and arranged to transmit light to the inside of the element; and a detector that is constructed and arranged to detect reflected light and produce a signal.

15. The device of claim 8 in which the thermochromic material is present on the surface of the interior wall of a hollow element; which can be illuminated by a light source positioned inside the element; and a detector that is constructed and arranged to detect reflected light and produce a signal.

16. A round flexible hollow body having an open end, an outer surface, and an inner surface, said round body formed of a thin membrane, with thermochromic pigment which exhibits a predetermined detectable change in color when the material is in contact with an object having a predetermined temperature, such pigment being immobilized onto or embodied into the membrane; said body to be used to be secured to an object to be inserted into an externally accessible body cavity.

17. The device of claim 16 further having a generally constant diameter from the open end to the other end to define a longitudinally extending tubular body.

18. The device of claim 16 further having an open end and a closed end, and a generally constant diameter from the open end to the other end to define a longitudinally extending tubular body.
